(19) United States
(12) Patent Application Publication
(10) Pub. No.: US 2011/0086587 A1
(43) Pub. Date: Apr. 14, 2011

(54) INDOOR GRILLING CABINET

(76) Inventor: Fred A. RAMLER, Hiawatha, IA (US)

(21) Appl. No.: 12/903,030

(22) Filed: Oct. 12, 2010

Related U.S. Application Data
(60) Provisional application No. 61/250,520, filed on Oct. 11, 2009.

(51) Int. Cl. B08B 15/02; F24F 7/007

(52) U.S. Cl. 454/67; 454/347

(57) ABSTRACT

An indoor grilling cabinet has a metal cabinet with at least one door opening to an interior portion. The cabinet is double walled with a plurality of openings in the interior wall to allow fresh air from outside to be drawn into the cabinet and exhausted through an exhaust hood disposed on top of the cabinet. A double walled exhaust pipe is provided to allow fresh air in to the air space between the double walled cabinet and to exhaust contaminated air to the outside. In one embodiment, a shelf is provided to allow a user to place a table-top grill in the cabinet. The exhaust pipe fits within an opening made in the structure or through a window with an optional window kit. An exhaust fan is disposed within the exhaust hood to draw the contaminated air out of the cabinet. In one embodiment, a light is provided.

### CROSS REFERENCE TO RELATED APPLICATIONS

This application claims priority and herein incorporates by reference U.S. provisional patent application 61/250,520, filed Oct. 11, 2009.

### BACKGROUND OF THE INVENTION

Most people enjoy grilled food as evidenced by the millions of grills sold in the United States alone. In general, grilling is done outdoors due to the smoke and other dangerous gasses produced during the grilling process. Restaurants have powerful but expensive exhaust hoods to allow them to grill food in their kitchens, but the average household is not so equipped. In most regions of the United States, this limits the grilling times to summer.

Some electric grills are made for inside use, but since they do not use a flame to cook, many people feel that they do not taste the same as food grilled using fire. There is a need for system that allows a user to grill inside a house or garage safely.

### SUMMARY OF THE INVENTION

An indoor grilling cabinet has a metal cabinet with at least one door opening to an interior portion. The cabinet is double walled with a plurality of openings in the interior wall to allow fresh air from outside to be drawn into the cabinet and exhausted through an exhaust hood disposed on top of the cabinet. A double walled exhaust pipe is provided to allow fresh air in to the air space between the double walled cabinet and to exhaust contaminated air to the outside. In one embodiment, a shelf is provided to allow a user to place a table-top grill in the cabinet. The exhaust pipe fits within an opening made in the structure or through a window with an optional window kit. An exhaust fan is disposed within the exhaust hood to draw the contaminated air out of the cabinet. In one embodiment, a light is provided.

Other features and advantages of the instant invention will become apparent from the following description of the invention which refers to the accompanying drawings.

### BRIEF DESCRIPTION OF THE DRAWINGS

FIG. 1 is a side view of an indoor grilling cabinet according to an embodiment of the invention.

FIG. 2 is a front view of the indoor grilling cabinet shown in FIG. 1.

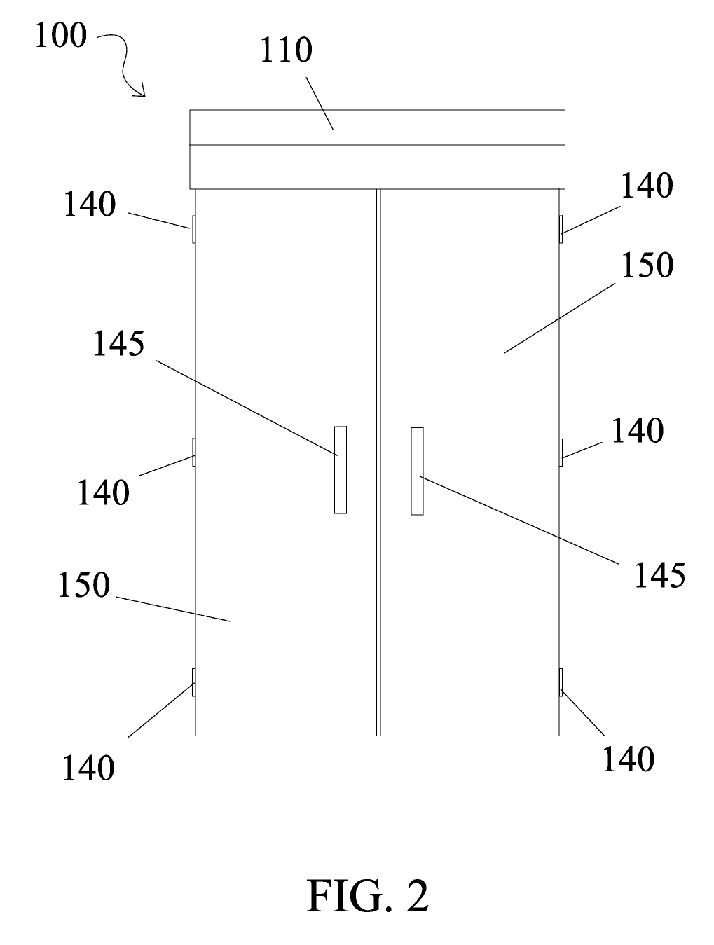

FIG. 3 is a front view of a four door indoor grilling cabinet according to an embodiment of the invention.

FIG. 4 is a front view with the doors open of the indoor grilling cabinet shown in FIG. 3.

FIG. 5 is a front view with the doors open of the indoor grilling cabinet shown in FIG. 2.

FIG. 6 is a cut-away side view of the indoor grilling cabinet according to an embodiment of the invention.

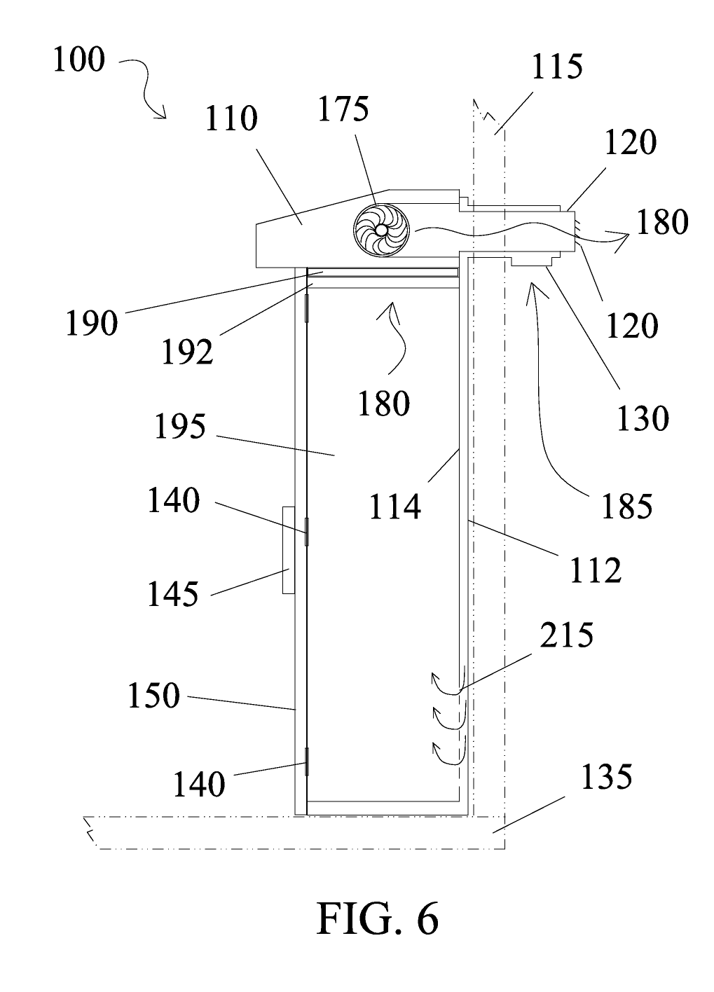

FIG. 7 is a front view of a lighted embodiment of the indoor grilling cabinet shown in FIG. 3.

FIG. 8 is a front view with the doors open of the indoor grilling cabinet shown in FIG. 3 with indicator lights and panel switches.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

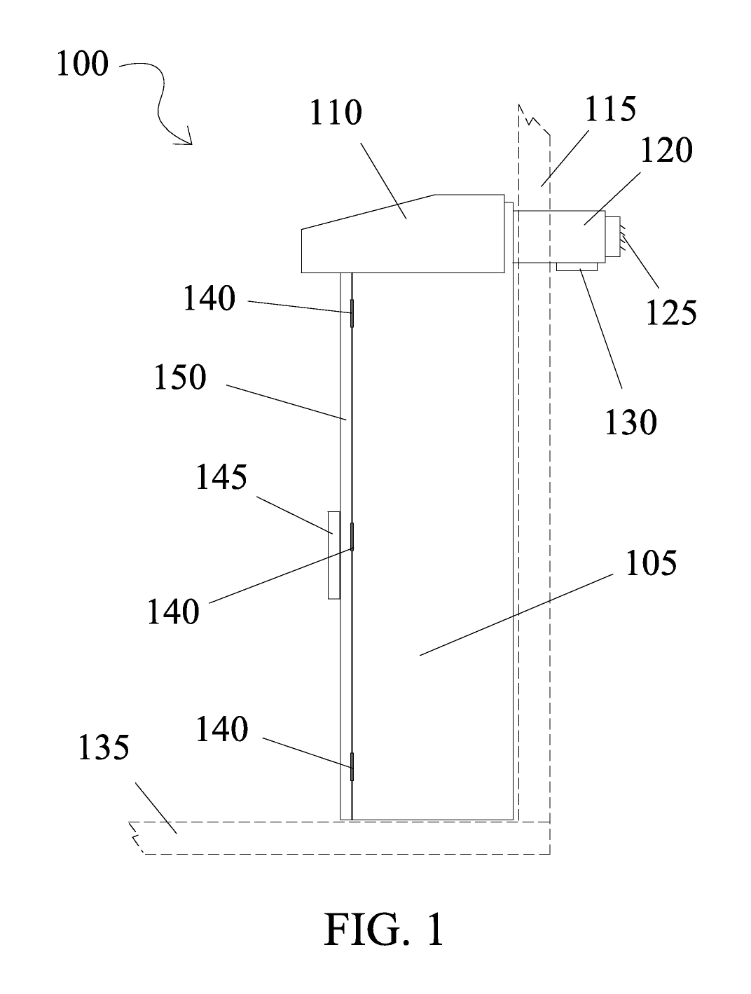

Referring to FIGS. 1,2 and 5 and 6, an indoor grilling cabinet 100 is shown having a cabinet 105 resting on a floor 135, a left and right cabinet doors 150 hingedly disposed on cabinet 105 using hinges 140. Each door 150 has a handle 145 to allow a user to open and close doors 150. An exhaust hood 110 is located above cabinet 105 to remove and transport combustion products outside of the structure housing indoor grilling cabinet 100. Cabinet 105 is double-walled with an outer wall 112 and an inner wall 114 which forms an air channel within.

A hole is cut into a wall 115 of a structure such as a garage, shed, or even kitchen or other room within a house. A double-walled duct pipe 120 connects to indoor grilling cabinet to the outside. An exhaust fan 175 is mounted within exhaust hood 110 to draw contaminated air 180 to the outside. An air intake 185 is mounted on duct pipe 120 in order to draw fresh air into indoor grilling cabinet 100 to provide the oxygen needed to grill. This arrangement allows grilling without drawing oxygen from the living structure and therefore does not deplete the oxygen level of the dwelling.

The inner pipe of duct pipe 120 is used to exhaust the contaminated air and the outer pipe draws fresh air 185 into an air flow wall 195 formed within cabinet 105. A plurality of air intake holes 215 are provided to draw fresh air through air intake 130 and air flow wall 195. Louvers 125 are used to keep environmental contaminants and rain or snow from entering.

Of course, it is only necessary to provide outside air to an interior portion of cabinet 105. Although air intakes 215 are shown as holes, other configurations would be suitable such as slots, ovals, grids, etc. without departing from the spirit of the invention. Additionally, double-walled pipe 120 could be square or some other shape. It would also be possible to separate the intake and exhaust functions by having two pipes.

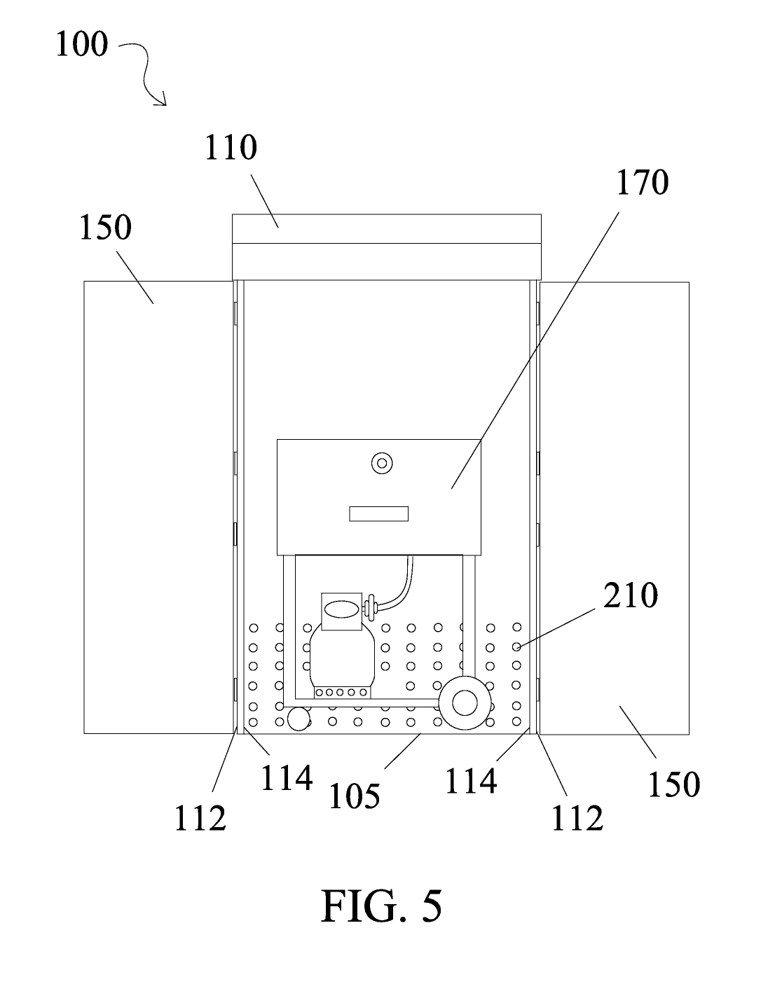

Now referring to FIG. 5, a gas grill 170 is shown fitting within indoor grilling cabinet 100. Of course grill 170 could be a charcoal grill as well. In operation, exhaust fan 175 is energized and then grill 170 is started (or charcoal is ignited). The user adjusts the temperature, checks the food, etc. with doors 150 open and then closes them to contain any gasses, soot and other products of combustion within cabinet. Fresh air is supplied to the interior of cabinet 100 even when doors 150 are closed through air intake 130, air flow wall 195 and air intake holes 215. Additionally, a single door (not shown) embodiment may be used without departing from the spirit of the invention. Also, although a shelf is shown in the four door embodiment, a shelf could be provided in a one or two door embodiment.

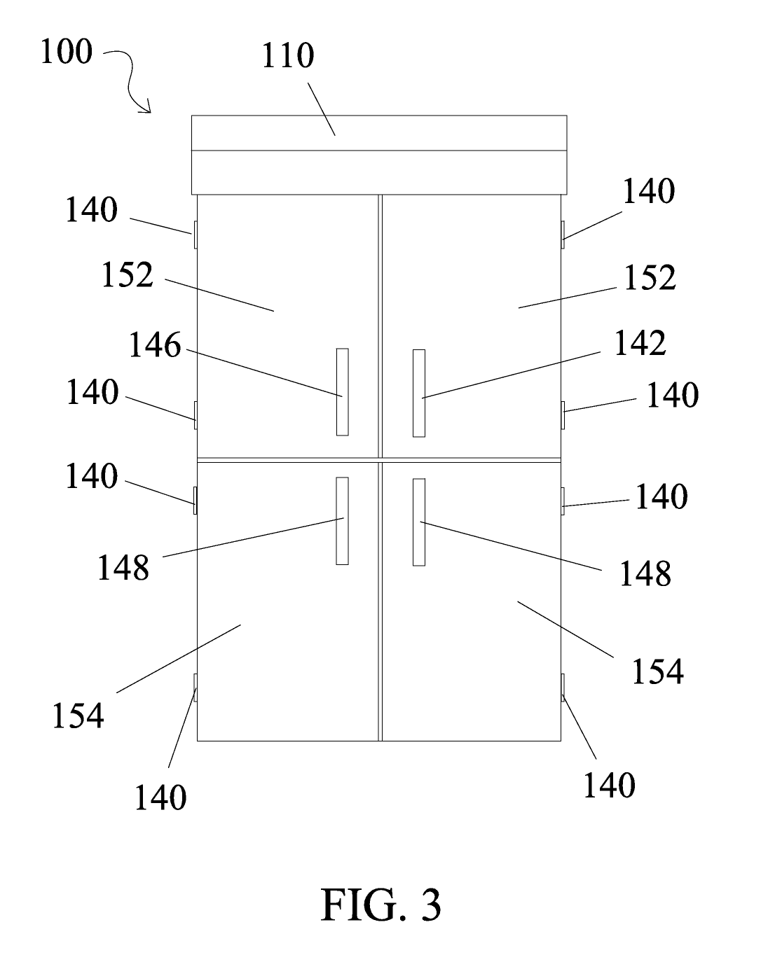

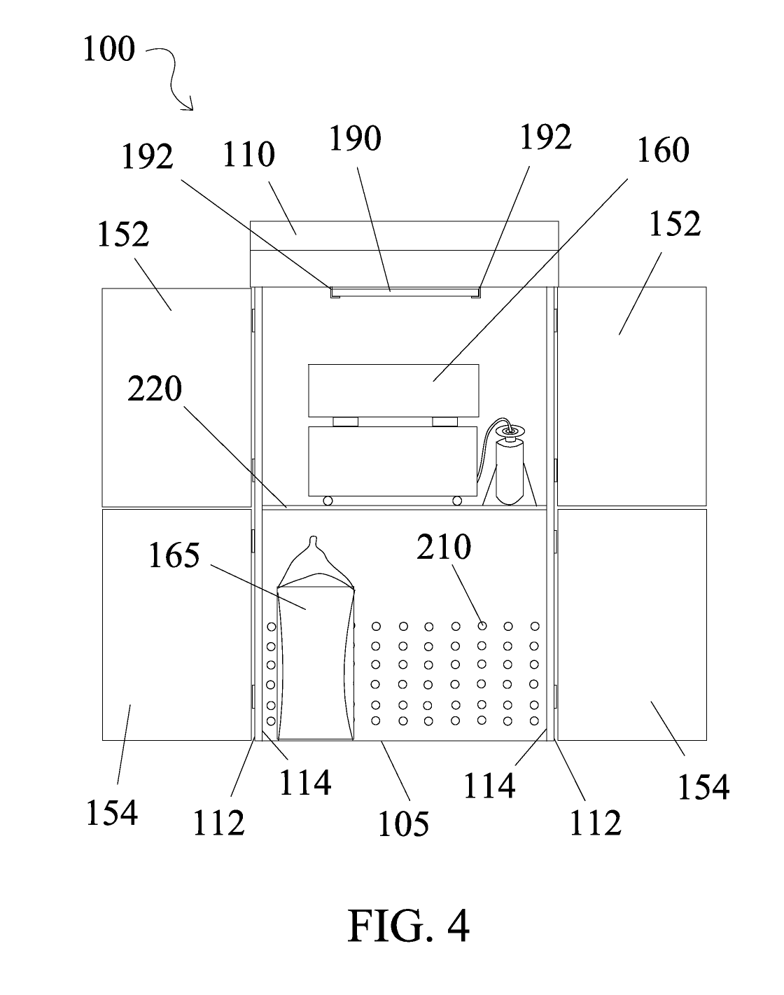

Referring now to FIGS. 3 and 4, a four door embodiment of an indoor grilling cabinet 100 is shown having a cabinet 105 with two upper doors 152 hingedly attached therein and two lower doors 154 hingedly attached as well. Upper and lower doors 152 and 154 have upper handles 146 and lower handles 148 respectively to allow a user easy access to the interior portion therein. A shelf 220 is provided to hold a tabletop grill 160. Shelf 220 has holes (not shown) provided to allow fresh air to flow through. A plurality of air intake holes 210 are provides to bring fresh air within cabinet 105 as discussed above.

An air filter 190 is provided to reduce pollutants from exhausting to the outside and to keep particulates from building up in exhaust hood 110. Two filter brackets 192 are provided to removably hold filter 190 enabling a user to replace as necessary.

Supplies 165 such as charcoal, grill cleaning tools, spare gas tanks, etc. can be stored in the lower space. In use, lower doors 154 may be closed and upper doors 152 opened to allow access to grill 160 and then closed to allow clean and safe grilling of food in an interior portion of a building without decreasing the level of oxygen or introducing dangerous contaminants such as carbon monoxide. Additionally, monitors such as smoke, fire and carbon monoxide detectors may be provided.

Indoor grilling cabinet 100 is made of metal or other suitable fireproof material. Additionally, a window kit (not shown) may be provided to allow the unit to be placed in a window to avoid the need to cut an opening in a structure as is known in the art.

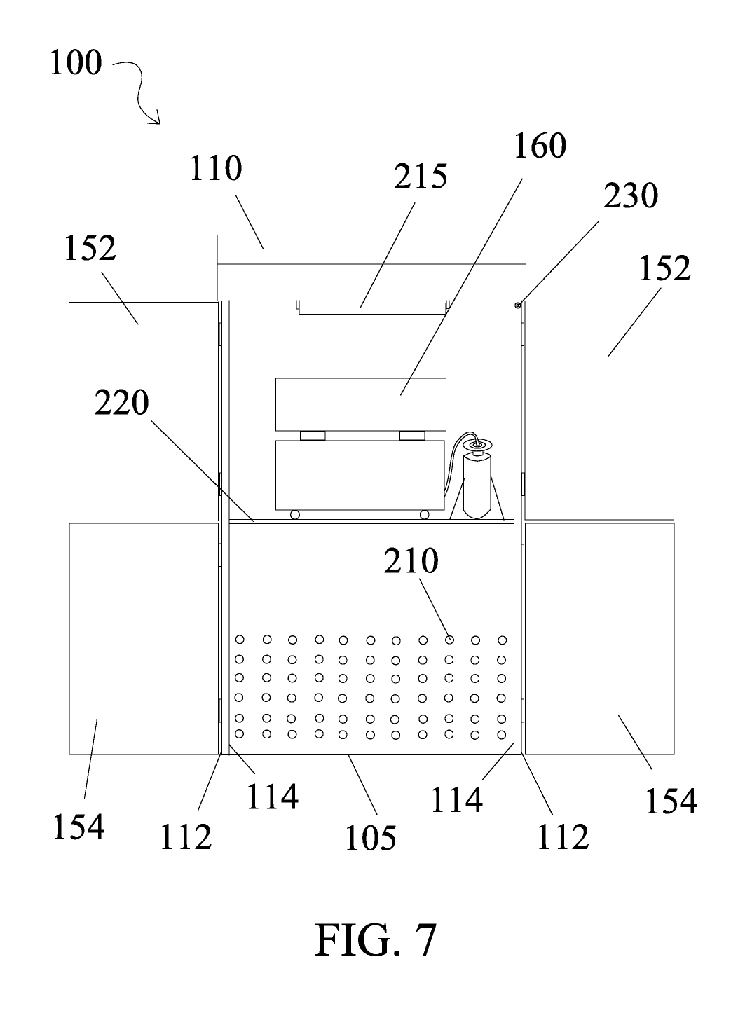

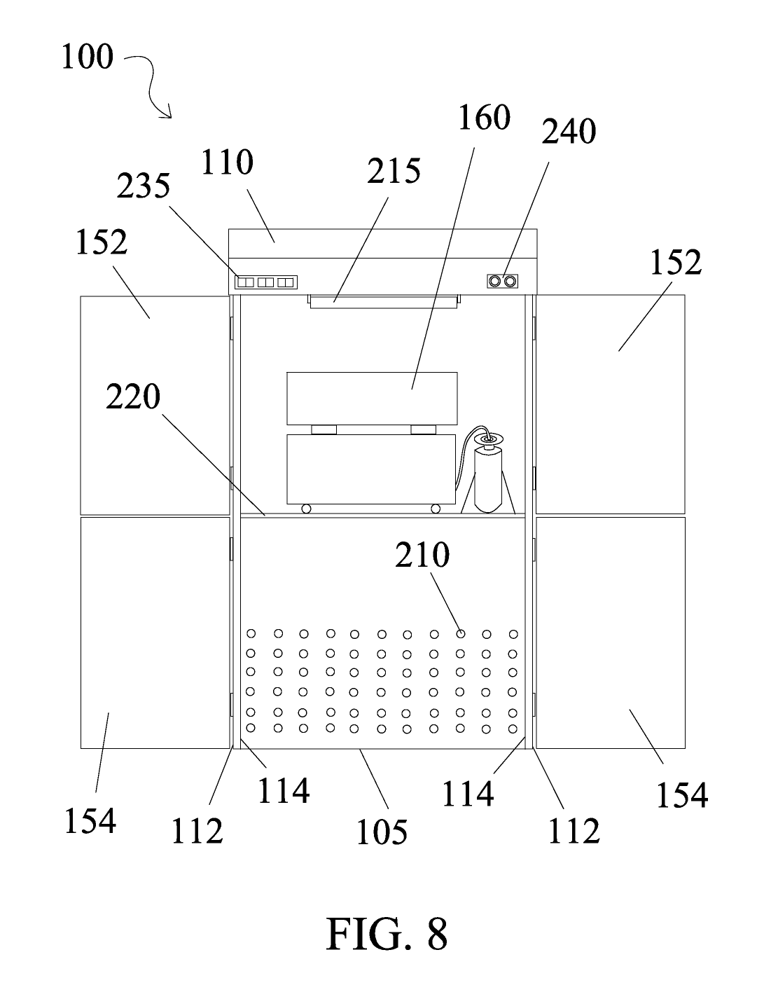

Referring now to FIGS. 7 and 8, indoor grilling cabinet 100 is shown with a light fixture 215. A switch 230 is used to automatically turn on light 215 when door 152 is opened. Of course other switches may be used such as toggle, light sensitive automatic, movement, etc. as is known in the art.

A switch panel 235 enables a user to control exhaust functions such as on/off, speed control and light function. An indicator panel 240 allows a user to visually confirm settings such as power on and speed, etc. Of course other kinds of indicators may be used including the use of automatic sensors to control the functions.

Although the instant invention has been described in relation to particular embodiments thereof, many other variations and modifications and other uses will become apparent to those skilled in the art.

What is claimed is:

1. An indoor grilling cabinet comprising:
a cabinet;
said cabinet having an outer wall and an inner wall;
an air space disposed between said outer wall and said inner wall;
a plurality of openings on a lower portion of said interior wall;
at least one hingedly attached door attached to said cabinet whereby a user has access to an interior portion of said cabinet;
an air exhaust hood disposed on said cabinet whereby contaminated air is removed from said cabinet;
an intake pipe in communication with said air space; and
an exhaust pipe in communication with said exhaust hood whereby air from inside said cabinet is exhausted.

2. The indoor grilling cabinet according to claim 1 further comprising at least one shelf disposed inside said cabinet.

3. The indoor grilling cabinet according to claim 2 wherein said at least one shelf has a plurality of holes whereby air can pass through.

4. The indoor grilling cabinet according to claim 1 further comprising a motorized fan unit disposed within said exhaust hood whereby air is forcibly moved therein.

5. The indoor grilling cabinet according to claim 4 further comprising a filter disposed on an inlet side of said exhaust hood whereby particulates are removed from the airstream.

6. The indoor grilling cabinet according to claim 5 wherein said filter has a charcoal portion to remove odors.

7. The indoor grilling cabinet according to claim 5 wherein said filter is replaceable.

8. The indoor grilling cabinet according to claim 1 further comprising at least one louver attached on an outer portion of said exhaust pipe.

9. The indoor grilling cabinet according to claim 1 further comprising an airtight seal disposed between said at least one hingedly attached door and a frame portion of said cabinet.

10. The indoor grilling cabinet according to claim 8 wherein said at least one louver is hinged to close when not in use whereby rain or snow is not allowed to enter.

11. The indoor grilling cabinet according to claim 1 further comprising a light disposed within said cabinet whereby a workspace area is lighted.

12. The indoor grilling cabinet according to claim 11 further comprising a switch to control said light.

13. The indoor grilling cabinet according to claim 4 further comprising a switch to control said motorized fan unit.

14. The indoor grilling cabinet according to claim 1 further comprising at least one indicator light to visually inform a user of a selected status.

15. The indoor grilling cabinet according to claim 14 wherein said selected status is power on and off.

16. The indoor grilling cabinet according to claim 4 further comprising a speed control unit for controlling the speed of said motorized fan unit.

17. The indoor grilling cabinet according to claim 1 further comprising a locking means for securing said at least one hingedly attached door.

18. The indoor grilling cabinet according to claim 17 whereby said locking means is a magnetic catch.

19. The indoor grilling cabinet according to claim 17 whereby said locking means is a mechanical latch.

20. The indoor grilling cabinet according to claim 1 whereby said cabinet is made from metal.
